(19) United States
(12) Patent Application Publication
(10) Pub. No.: US 2009/0249910 A1
(43) Pub. Date: Oct. 8, 2009

(54) LEAD SCREW DEVICE

(75) Inventors: Kenneth W. Erikson, Amherst, NH (US); Keith W. Erikson, Hollis, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Kerk Motion Products, Inc., Hollis, NH (US)

(21) Appl. No.: 12/098,166

(22) Filed: Apr. 4, 2008

(51) Int. Cl. F16H 55/56

(52) U.S. Cl. 74/424.83

(57) ABSTRACT

A lead screw device including a lead screw shaft extending along a longitudinal axis having a lead screw thread portion, and a coupling structure at a proximal end of the lead screw shaft. The coupling structure can have a male securement thread and a female securement thread positioned along the longitudinal axis. The female securement thread can extend within the coupling structure at the proximal end of the lead screw shaft. The coupling structure can provide opposed axial threaded securement to a rotatable shaft along the longitudinal axis from opposing axial directions.

### BACKGROUND

Small motor driver linear actuators can include a motor that drives a rotatable lead screw. The threads on the lead screw can engage a threaded nut which converts rotational motion of the lead screw into linear motion. A common method of coupling the lead screw to the motor is to press fit the lead screw and the output shaft of the motor together. A drawback of this design is that the process of press fitting can cause damage to the lead screw and/or the motor. In addition, the press fit joint can have concentricity problems, and during operation, the press fit joint can experience axial and radial slippage, affecting the performance and accuracy of the linear actuator.

### SUMMARY

The present invention can provide a lead screw device including a lead screw shaft extending along a longitudinal axis and having a lead screw thread portion, and a coupling structure at a proximal end of the lead screw shaft. The coupling structure can have a male securement thread and a female securement thread positioned along the longitudinal axis. The female securement thread can extend within the coupling structure at the proximal end of the lead screw shaft. The coupling structure can provide opposed axial threaded securement to a rotatable shaft along the longitudinal axis from opposing axial directions.

In particular embodiments, a threaded fastener can be included for engaging the female securement thread of the coupling structure. A hollow rotatable drive shaft can be included and can have a central opening with a female threaded region for engaging the male securement thread of the lead screw shaft for securing the lead screw shaft to the drive shaft from a first axial direction. The central opening can include an access hole extending to the female threaded region for providing access for insertion and securement of the threaded fastener into the female securement thread of the coupling structure from a second axial direction opposite to the first axial direction. The central opening can have a first drive shaft shoulder between the female threaded region and the access hole, upon which the threaded fastener is capable of being tightened against. The lead screw shaft can include a locating diameter for engaging a locating diameter of the drive shaft for aligning the lead screw shaft with the drive shaft along the longitudinal axis. The locating diameter of the drive shaft can be a locating bore within the drive shaft which is separated from the female threaded region of the central opening by a second drive shaft shoulder. The locating diameter of the lead screw shaft can be separated from the male securement thread by a lead screw shaft shoulder that is capable of being tightened against the second drive shaft shoulder. The female securement thread can be coaxially positioned within the male securement thread of the Is coupling structure. The male and female securement threads can be configured to provide rotational tightening from opposed rotational directions. The lead screw device can further include a motor in which the rotatable drive shaft can be an output shaft of the motor. A lead screw nut can be included which can engage the lead screw thread portion of the lead screw shaft for converting a rotation of the lead screw shaft into linear motion of the lead screw nut. An anti rotational spline member can be secured to the lead screw nut. The anti rotational spline member can be generally tubular with a central cavity. The lead screw nut being formed from thermoplastic material injection molded into the cavity of the spline member. The central cavity of the spline member can have longitudinal grooves into which the thermoplastic material extends for stabilizing the lead screw nut.

The present invention can also provide a lead screw device including a hollow rotatable drive shaft having a central opening with a female threaded region and an access hole extending to the female threaded region. A first drive shaft shoulder can be between the female threaded region and the access hole. A lead screw shaft can extend along a longitudinal axis and can have a lead screw thread portion, and a coupling structure at a proximal end of the lead screw shaft. The coupling structure can have a male securement thread and a female securement thread positioned along the longitudinal axis. The female securement thread can be coaxially positioned within the male securement thread of the coupling structure at the proximal end of the lead screw shaft. The male securement thread can engage the female threaded region of the drive shaft for securing the lead screw shaft to the drive shaft from a first axial direction. A threaded fastener can be inserted through the access hole of the drive shaft and engage the female securement thread of the coupling structure from a second axial direction opposite to the first axial direction to form opposed coaxial threaded securement of the lead screw shaft to the drive shaft along the longitudinal axis from opposing axial directions.

The present invention can also provide a method of securing a lead screw device to a rotatable drive shaft including forming the drive shaft to be hollow having a central opening with a female threaded region and an access hole extending to the female threaded region. A first drive shaft shoulder can be between the female threaded region and the access hole. The lead screw device can have a lead screw shaft extending along a longitudinal axis and can have a lead screw thread portion, and a coupling structure at a proximal end of the lead screw shaft. The coupling structure can have a male securement thread and a female securement thread positioned along the longitudinal axis. The female securement thread can be positioned within the coupling structure at the proximal end of the lead screw shaft. The male securement thread can engage the female threaded region of the drive shaft for securing the lead screw shaft to the drive shaft from a first axial direction. A threaded fastener can be inserted through the access hole of the drive shaft and engage the female securement thread of the coupling structure of the lead screw shaft from a second axial direction opposite to the first axial direction to form opposed axial threaded securement of the lead screw shaft to the drive shaft along the longitudinal axis from opposing axial directions.

In particular embodiments, the hollow rotatable drive shaft can have a first drive shaft shoulder between the female threaded region and the access hole, upon which the threaded fastener can be tightened against. The lead screw shaft can have a locating diameter for engaging a locating diameter of the drive shaft for aligning the lead screw shaft with the drive shaft along the longitudinal axis. The locating diameter of the drive shaft can be a locating bore within the drive shaft which is separated from the female threaded region of the central opening by a second drive shaft shoulder. The locating diameter of the lead screw shaft can be separated from the male securement thread by a lead screw shaft shoulder that is tightened against the second drive shaft shoulder. The female securement thread can be coaxially positioned within the male securement thread of the coupling structure. The male and female securement threads can be configured to provide rotational tightening from opposed rotational directions. The lead screw shaft can be secured to the rotatable drive shaft of a motor. The lead screw device can include a lead screw nut engaging the lead screw thread portion of the lead screw shaft for converting rotation of the lead screw shaft into linear motion of the lead screw nut. The lead screw device can include an anti rotational spline member secured to the lead screw nut. The anti rotational spline member can be generally tubular with a central cavity. The lead screw nut can be formed from thermoplastic material injection molded into the cavity of the spline member. The central cavity of the spline member can have longitudinal grooves into which the thermoplastic material extends for stabilizing the lead screw nut.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an end view of an embodiment of a linear actuator in the present invention.

FIG. 2 and 3 are side sectional views of the linear actuator of FIG. 1.

FIG. 4 is an enlarged view of the securement of the lead screw to the output shaft of the motor.

FIG. 5 is a side view of the securement of the lead screw to the output shaft of the motor.

FIG. 6 is an end view of a spline member with a threaded insert lead screw nut.

FIG. 7 is a side view of another embodiment of securement of a lead screw to an output shaft of a motor.

### DETAILED DESCRIPTION

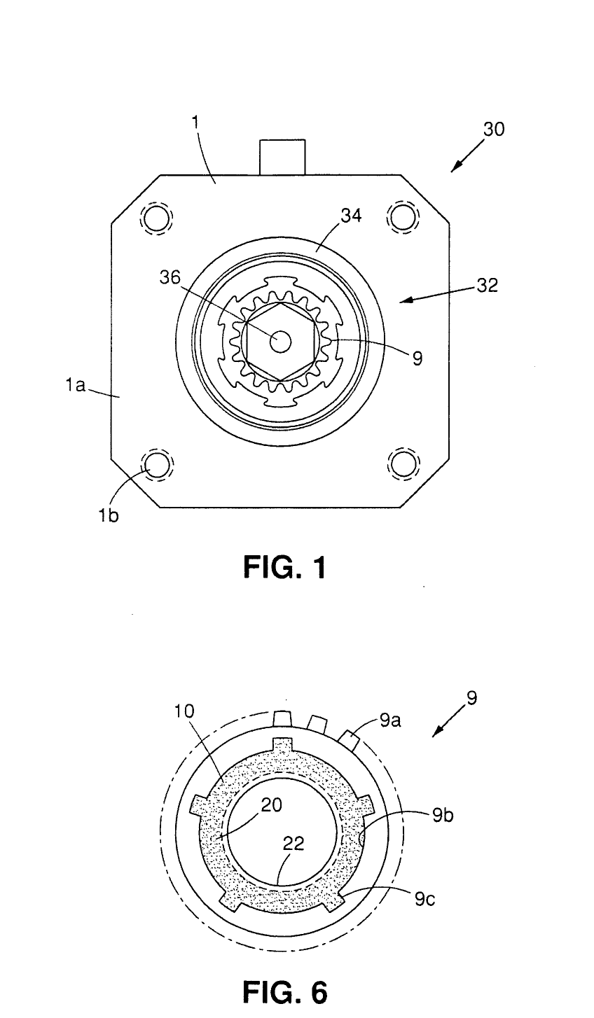

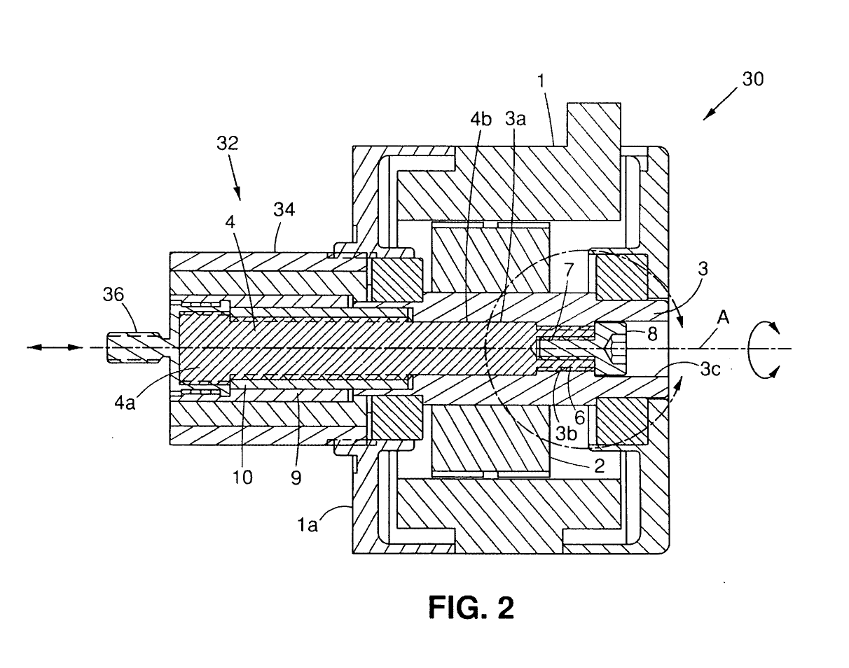

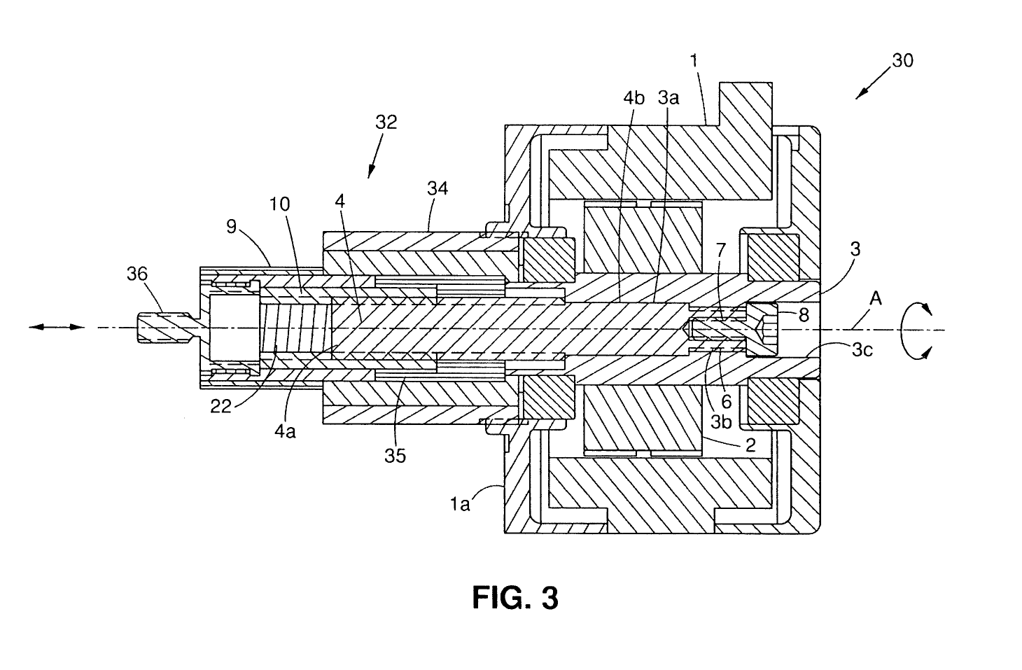

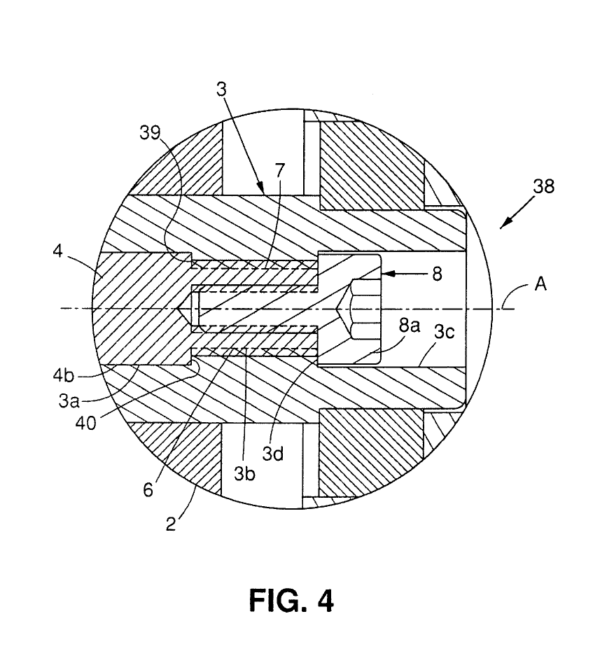

Referring to FIGS. 1-5, linear actuator 30 can include a motor 1, for example, an electric motor, which can be a computer controlled stepper or servo motor. Motor 1 can have a rotor 2 and a rotatable output rotor or motor drive shaft 3 for rotationally driving a lead screw assembly 32 mounted to the motor 1. The lead screw assembly 32 can convert rotational motion of the motor shaft 3 into linear motion as shown by the arrows. The lead screw assembly 32 can include a lead screw shaft 4 that is secured to motor shaft 3 along a longitudinal axis A. The lead screw 4 drives a threaded lead screw nut or driven member 10 linearly with rotation of the lead screw 4. An anti backlash nut 35 or assembly can be included to reduce or take up backlash. An anti rotational male spline or spline member 9 secured to the lead screw nut 10 can prevent rotation of the lead screw nut 10. The male spline member 9 can slidably engage an outer female spline housing 34 that is secured to the housing of motor 1. A mounting protrusion, structure or member 36 can extend from the spline member 9 for mounting the lead screw assembly 32 to a desired component or device for linear motion, driving or adjustment, which can be in reciprocal or alternating directions. The mounting member 36 can be a threaded member as shown, or other suitable mounting or securement structures. The motor 1 can have a mounting or face plate 1 a having a series of threaded holes 1b for mounting the motor 1 to a fixture.

The lead screw 4 can extend along longitudinal axis A and can have a lead screw thread portion or region 4a for engaging and driving the lead screw nut 10, and a coupling structure 12 at a proximal end for securement to the motor shaft 3. The coupling structure 12 can have a male locating diameter portion or region 4b, which can be a turned down, reduced or smaller diameter relative to the diameter of the lead screw thread portion 4a. A male securement thread or threaded portion or region 6 can extend from the locating diameter portion 4b and can have a smaller diameter than the locating diameter portion 4b. An internal female securement hole, thread, or threaded portion or region 7 can extend within the coupling structure 12 at the proximal end of the lead screw 4. The female securement thread 7 can be axially positioned within the coupling structure 12 and can be concentrically or coaxially positioned within or relative to the male securement thread 6.

The output motor shaft 3 of the motor 1 can be hollow with an opening or cavity 38 extending therethrough along longitudinal axis A. The opening 38 can have a smooth bore female locating diameter portion or region 3a, a female internal securement thread, threaded portion, hole or region 3b, and an access hole 3c. Typically, the female threaded region 3b has a smaller diameter than smooth bore portion 3a and access hole 3c. The smooth bore portion 3a can engage the locating diameter potion 4b of the lead screw 4 for concentrically positioning or locating the lead screw 4 within motor shaft 3 along the longitudinal axis A. The female threaded region 3b can engage the male securement thread 6 of the lead screw 4 for securing the lead screw 4 to the motor shaft 3. A threaded fastener 8, such as a bolt or cap screw, can be secured to the motor shaft 3 and the coupling structure 12 of the lead screw 4 by engaging the female securement thread 7. The threaded fastener 8 can be inserted into the motor shaft 3 through the access hole 3c which is on the opposite axial side of the female threaded region 3b from the smooth bore portion 3a. The access hole 3c can have a diameter large enough to provide clearance for the head 8a of the threaded fastener 8.

When securing the lead screw 4 to the motor shaft 3, the male securement thread 6 of the coupling structure 12 of the lead screw 4 can be tightened within the female threaded region 3b of the motor shaft 3 from a first axial direction until shoulder 40 of the lead screw 4 engages and is tightened or compressed against shoulder 39 of the motor shaft 3. The male securement thread 6 can be in tension and can be shorter than the length of the threaded region 3b. The threaded fastener 8 can be inserted through the access hole 3c of the motor shaft 3 from the opposite or a second axial direction into the female threaded hole 7 of the coupling structure 12 of the lead screw 4 and tightened until the head 8a of the threaded fastener 8 is tightened to or compressed against shoulder 3d at the end of access hole 3c and/or the female threaded hole 7. The threaded fastener 8 can further compress the shoulder 40 of the lead screw 4 against shoulder 39 and further exert tension forces on the male securement thread 6. This can secure the lead screw 4 to the motor shaft 3 with concentric or coaxial threaded members that are engaged and tightened from opposite axial directions, thereby locking the lead screw 4 in place. The threads of the male securement thread 6 and female securement thread 7 and fastener 8 can be in the same helical direction, for example, all right hand threads, or all left hand threads, so that the threads of the male securement thread 6 within threaded region 3b, and the threaded fastener 8 within female securement thread 7, engage in opposing axial directions, and can be tightened in opposing rotational directions. As a result, alternating rotation of motor shaft 3 can always be in a rotational tightening direction of one of the threads, either relative to the male securement thread 6 and threaded region 3b, or the threaded fastener 8 and female securement thread 7. Consequently, loosening or rotational slipping of the lead screw 4 relative to the motor shaft 3 can be prevented or minimized. If desired, a lock washer can be employed with the threaded fastener 8, or the threaded fastener 8 can include a polymeric protrusion which engages the female securement thread 7 for locking purposes. A polymeric protrusion can also be on male securement thread 6.

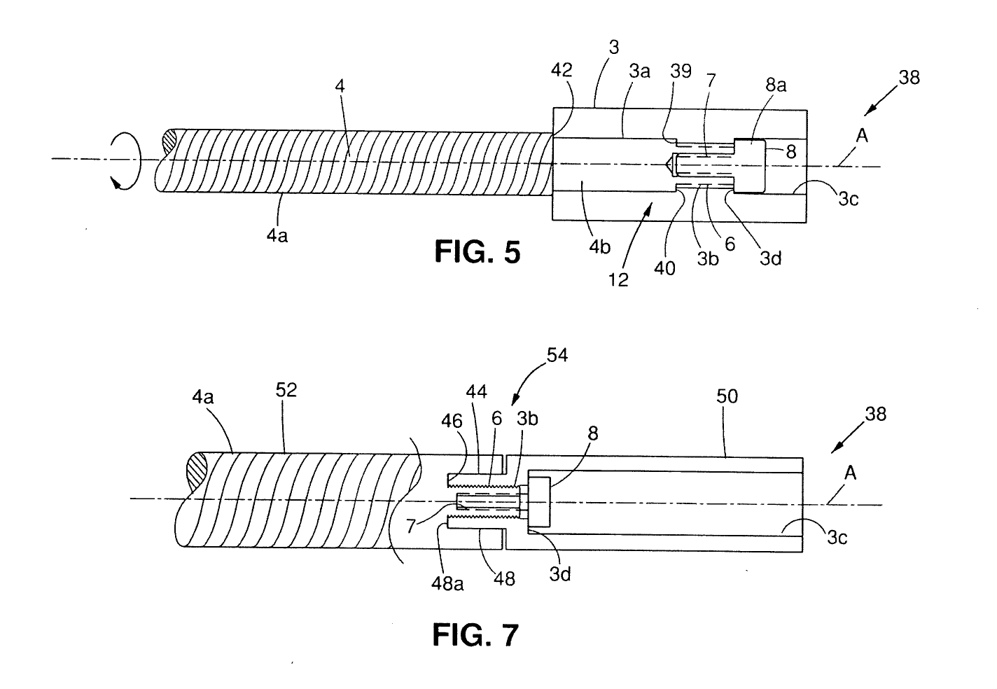

In some embodiments, the positions or locations of the locating diameter 4b and the male securement thread 6 can be exchanged or switched. In addition, the locating diameter 4b of the lead screw 4 can be omitted and the lead screw thread portion 4a can be used as the locating diameter. Furthermore, in some embodiments, other shoulders, such as at the end of the lead screw thread portion 4a, for example 42 in FIG. 5, can be axially tightened against a shoulder or face of the motor shaft 3. In some embodiments, motor 1 can be a non electrical motor such as a hydraulic, fluid or gas driven motor.

Referring to FIG. 6, spline member 9 can be generally hollow or tubular in shape with exterior or male longitudinal splines 9a. A central cavity, hole or opening 9b can extend through the spline member 9 and can include longitudinal internal or female grooves, recesses or cavities 9c. The lead screw nut 10 can be secured within the spline member 9. The lead screw nut 10 can be formed from an insert 20 of thermoplastic material injection molded into the central opening 9b of the spline member 9. The thermoplastic material can extend into the grooves 9c which can help secure the insert 20 in position as well as rotationally lock the insert 20 to the spline member 9. An internal female threaded hole 22 can be formed into the insert 20. The female threaded hole 22 can be tapped, or alternatively can be molded. The lead screw nut 10 can be formed of a suitable long wearing plastic, such as nylon, Delrin etc., to provide long wear and minimize the formation of particles.

Referring to FIG. 7, in another embodiment, lead screw 52 can have a coupling structure 54 with a female locating diameter 44 for engaging a male protrusion locating diameter 48 extending from rotatable output motor shaft 50 and aligning the lead screw 52 and motor shaft 50 along axis A. The male securement thread 6 can be positioned and extend coaxially or concentrically within locating diameter 44, such that the region between the female locating diameter 44 and male securement thread 6 can be annular in shape. The male securement thread 6 can engage the female threaded hole 3b of the male protrusion locating diameter 48 for securing the lead screw 52 to the motor shaft 50. The end 48a of the male protrusion locating diameter 48 can be tightened against end face 46 of the female locating diameter 44. Alternatively, the end faces radially outside diameter 48 can be tightened together. Threaded fastener 8 can engage the female securement thread 7 within coupling structure 54 and can be tightened against shoulder 3d to lock the lead screw 52 to the motor shaft 50 concentrically or coaxially from opposite axial directions. Opposite rotational tightening or locking can also be obtained.

While this invention has been particularly shown and described with references to example embodiments thereof, it will be understood by those skilled in the art that various changes in form and details may be made therein without departing from the scope of the invention encompassed by the appended claims.

What is claimed is:

1. A lead screw device comprising:
a lead screw shaft extending along a longitudinal axis having a lead screw thread portion, and a coupling structure at a proximal end of the lead screw shaft, the coupling structure having a male securement thread and a female securement thread positioned along the longitudinal axis, the female securement thread extending within the coupling structure at the proximal end of the lead screw shaft, the coupling structure for providing opposed axial threaded securement to a rotatable shaft along the longitudinal axis from opposing axial directions.

2. The lead screw device of claim 1 further comprising a threaded fastener for engaging the female securement thread.

3. The lead screw device of claim 2 further comprising a hollow rotatable drive shaft having a central opening with a female threaded region for engaging the male securement thread of the lead screw shaft for securing the lead screw shaft to the drive shaft from a first axial direction, the central opening including an access hole extending to the female threaded region for providing access for insertion and securement of the threaded fastener into the female securement thread of the coupling structure from a second axial direction opposite to the first axial direction, the central opening having a first drive shaft shoulder between the female threaded region and the access hole, upon which the threaded fastener is capable of being tightened against.

4. The lead screw device of claim 3 in which the lead screw shaft includes a locating diameter for engaging a locating diameter of the drive shaft for aligning the lead screw shaft with the drive shaft along the longitudinal axis.

5. The lead screw device of claim 4 in which the locating diameter of the drive shaft is a locating bore within the drive shaft which is separated from the female threaded region of the central opening by a second drive shaft shoulder, the locating diameter of the lead screw shaft being separated from the male securement thread by a lead screw shaft shoulder that is capable of being tightened against the second drive shaft shoulder.

6. The lead screw device of claim 1 in which the female securement thread is coaxially positioned within the male securement thread of the coupling structure.

7. The lead screw device of claim 1 on which the male and female securement threads are configured to provide rotational tightening from opposed rotational directions.

8. The lead screw device of claim 4 further comprising a motor, the rotatable drive shaft being an output shaft of the motor.

9. The lead screw of claim 1 further comprising a lead screw nut engaging the lead screw thread portion of the lead screw shaft for converting rotation of the lead screw shaft into linear motion of the lead screw nut.

10. The lead screw device of claim 9 further comprising an anti rotational spline member secured to the lead screw nut.

11. The lead screw device of claim 10 in which the anti rotational spline member is generally tubular with a central cavity, the lead screw nut being formed from thermoplastic material injection molded into the cavity of the spline member, the central cavity of the spline member having longitudinal grooves into which the thermoplastic material extends for stabilizing the lead screw nut.

12. A lead screw device comprising:
a hollow rotatable drive shaft having a central opening with a female threaded region and an access hole extending to the female threaded region, a first drive shaft shoulder being between the female threaded region and the access hole;
a lead screw shaft extending along a longitudinal axis having a lead screw thread portion, and a coupling structure at a proximal end of the lead screw shaft, the coupling structure having a male securement thread and a female securement thread positioned along the longitudinal axis, the female securement thread being coaxially positioned within the male securement thread of the coupling structure at the proximal end of the lead screw shaft, the male securement thread for engaging the female threaded region of the drive shaft for securing the lead screw shaft to the drive shaft from a first axial direction; and
a threaded fastener for insertion through the access hole of the drive shaft and engaging the female securement thread of the coupling structure from a second axial direction opposite to the first axial direction to form opposed coaxial threaded securement of the lead screw shaft to the drive shaft along the longitudinal axis from opposing axial directions.

13. A method of securing a lead screw device to a rotatable drive shaft comprising:
forming the drive shaft to be hollow having a central opening with a female threaded region and an access hole extending to the female threaded region, a first drive shaft shoulder being between the female threaded region and the access hole;
providing the lead screw device with a lead screw shaft extending along a longitudinal axis having a lead screw thread portion, and a coupling structure at a proximal end of the lead screw shaft, the coupling structure having a male securement thread and a female securement thread positioned along the longitudinal axis, the female securement thread being positioned within the coupling structure at the proximal end of the lead screw shaft, the male securement thread for engaging the female threaded region of the drive shaft for securing the lead screw shaft to the drive shaft from a first axial direction; and
inserting a threaded fastener through the access hole of the drive shaft and engaging the female securement thread of the coupling structure of the lead screw shaft from a second axial direction opposite to the first axial direction to form opposed axial threaded securement of the lead screw shaft to the drive shaft along the longitudinal axis from opposing axial directions.

14. The method of claim 13 further comprising providing the hollow rotatable drive shaft with a first drive shaft shoulder between the female threaded region and the access hole, upon which the threaded fastener is tightened against.

15. The method of claim 14 further comprising providing the lead screw shaft with a locating diameter for engaging a locating diameter of the drive shaft for aligning the lead screw shaft with the drive shaft along the longitudinal axis.

16. The method of claim 15 further comprising forming the locating diameter of the drive shaft as a locating bore within the drive shaft which is separated from the female threaded region of the central opening by a second drive shaft shoulder, the locating diameter of the lead screw shaft being separated from the male securement thread by a lead screw shaft shoulder that is tightened against the second drive shaft shoulder.

17. The method of claim 13 further comprising coaxially positioning the female securement thread within the male securement thread of the coupling structure.

18. The method of claim 13 further comprising configuring the male and female securement threads to provide rotational tightening from opposed rotational directions.

19. The method of claim 15 further comprising securing the lead screw shaft to the rotatable drive shaft of a motor.

20. The method of claim 13 further comprising providing the lead screw device with a lead screw nut engaging the lead screw thread portion of the lead screw shaft for converting rotation of the lead screw shaft into linear motion of the lead screw nut.

21. The method of claim 20 further comprising providing the lead screw device with an anti rotational spline member secured to the lead screw nut, the anti rotational spline member being generally tubular with a central cavity, the lead screw nut being formed from thermoplastic material injection molded into the cavity of the spline member, the central cavity of the spline member having longitudinal grooves into which the thermoplastic material extends for stabilizing the lead screw nut.
